(19) United States
(12) Patent Application Publication
(10) Pub. No.: US 2009/0141711 A1
(43) Pub. Date: Jun. 4, 2009

(54) Interleaved Multistage Switching Fabrics And Associated Methods

(75) Inventors: Rongsen He, Pullman, WA (US); Jose G. Delgado-Frias, Pullman, WA (US)

Correspondence Address: LATHROP & GAGE LLP, 4845 PEARL EAST CIRCLE, SUITE 201, BOULDER, CO, 80301, US

(73) Assignee: WASHINGTON STATE UNIVERSITY RESEARCH FOUNDATION, Pullman, WA (US)

(21) Appl. No.: 12/323,965

(22) Filed: Nov. 26, 2008

Related U.S. Application Data
(60) Provisional application No. 60/990,144, filed on Nov. 26, 2007.

(51) Int. Cl. H04Q 11/00; H04L 12/50

(52) U.S. Cl. 370/388

(57) ABSTRACT

An interleaved multistage switching fabric includes Y multistage switching fabric panels, where Y is an integer greater than one. Each panel has primary inputs for receiving cells to be routed, local outputs for outputting routed cells, primary outputs for outputting non-routed cells, and reentry points for introducing non-routed cells into the panel. The switching fabric additionally includes at least one demultiplexer subsystem communicatively coupled to primary inputs of each panel, for interfacing the switching fabric with input lines. The switching fabric further includes at least one multiplexer subsystem communicatively coupled to local outputs of each panel, for interfacing the switching fabric with destination queues. The switching fabric additionally includes Y recirculation connections, where each recirculation connection communicatively couples primary outputs of one panel to reentry points of another panel.

### CROSS-REFERENCE TO RELATED APPLICATIONS

This application claims benefit of priority to U.S. Provisional Patent Application Ser. No. 60/990,144, filed 26 Nov. 2007, which is incorporated herein by reference.

### BACKGROUND

Routers are key components in computer networks, such as the Internet. As network applications have demanded increased router performance, router architecture has evolved from using a shared backplane to a switched backplane. At present, many routers are based on a single stage crossbar architecture. However, single stage crossbar routers typically require complex schedulers and have a complexity of O(N²) that grows exponentially as a function of network size N. Accordingly, single stage crossbar routers practically support only a limited number of interconnections and may not be scalable for next generation networks, which may incorporate the Internet, telecommunication services (such as Skype), and TV services (such as IP TV).

One alternative to the single stage crossbar architecture are delta class networks, such as multistage interconnected networks (“MINs”) including Banyan, Omega, Baseline, reverse Baseline, and indirect binary n-Cube networks. Delta class networks may be attractive for use in high speed switching fabrics due to their simple self-routing and their complexity of O(N×log₂N). However, delta class networks can suffer from internal blocking, resulting in poor throughput under some traffic patterns. Blocking occurs because delta class networks are not permutation networks; that is, a delta class network can not implement all input permutations with a single copy (log₂N stages) of such a network.

Another alternative to the single stage crossbar architecture are output-queued multistage interconnected networks with b×2b switching elements. The number of cells that can be concurrently switched from the inlets to each output queue equals the number of stages in the interconnection network. However, more stages are required to achieve higher throughput, which can increase both latency and hardware cost.

There is a need for scalable high performance routers and switches to provide a larger number of ports, higher throughput, and good reliability.

### SUMMARY

In an embodiment, an interleaved multistage switching fabric includes Y multistage switching fabric panels, where Y is an integer greater than one. Each panel has primary inputs for receiving cells to be routed, local outputs for outputting routed cells, primary outputs for outputting non-routed cells, and reentry points for introducing non-routed cells into the panel. The switching fabric additionally includes at least one demultiplexer subsystem communicatively coupled to primary inputs of each panel, for interfacing the switching fabric with input lines. The switching fabric further includes at least one multiplexer subsystem communicatively coupled to local outputs of each panel, for interfacing the switching fabric with destination queues. The switching fabric additionally includes Y recirculation connections, where each recirculation connection communicatively couples primary outputs of one panel to reentry points of another panel.

In an embodiment, an interleaved multistage switching fabric includes Y multistage switching fabric panels, where Y is an integer greater than one. Each panel has an I-Cubeout architecture and a plurality of stages of switching elements. Adjacent stages are interconnected according to an indirect n-cube connecting pattern. Each panel has primary outputs for outputting non-routed cells and reentry points for introducing non-routed cells into the panel. The switching fabric additionally includes Y recirculation connections, where each recirculation connection communicatively couples primary outputs of one panel to reentry points of another panel.

In an embodiment, a method for recirculating cells that fail to route in a switching fabric includes receiving a first cell that failed to route from a primary output of a first multistage switching fabric panel. The first cell is introduced into a reentry point of a second multistage switching fabric panel.

### BRIEF DESCRIPTION OF DRAWINGS

FIG. 1 shows one multistage switching fabric panel.

FIG. 2 shows another multistage switching fabric panel.

FIG. 3 shows one multistage switching fabric panel with recirculation, according to an embodiment.

FIG. 4 shows one interleaved multistage switching fabric, according to an embodiment.

FIG. 5 shows another interleaved multistage switching fabric, according to an embodiment.

FIG. 6 shows one method for recirculating cells that failed to route in a switching fabric, according to an embodiment.

FIG. 7 shows one graph of mean latency versus offered load under uniform traffic conditions.

FIG. 8 shows one graph of drop rate versus offered load under uniform traffic conditions.

FIG. 9 shows one graph of mean latency versus offered load under hot spot traffic conditions.

FIG. 10 shows one graph of drop rate versus offered load under hot spot traffic conditions.

FIG. 11 shows one graph of mean latency versus offered load under hot spot traffic conditions.

FIG. 12 shows one graph of drop rate versus offered load under hot spot traffic conditions.

FIG. 13 shows one graph of mean latency versus offered load under no fault and single fault conditions.

FIG. 14 shows one graph of drop rate versus offered load under no fault and single fault conditions.

FIG. 15 shows one graph of mean latency versus offered load under no fault and single fault conditions.

FIG. 16 shows one graph of drop rate versus offered load under no fault and single fault conditions.

FIG. 17 shows one graph of mean latency versus offered load under no fault and multiple fault conditions.

FIG. 18 shows one graph of drop rate versus offered load under no fault and multiple fault conditions.

### DETAILED DESCRIPTION OF THE EMBODIMENTS

Specific instances of an item may be referred to by use of a numeral in parentheses (e.g., switching element 102(1)) while numerals without parentheses refer to any such item (e.g., switching elements 102).

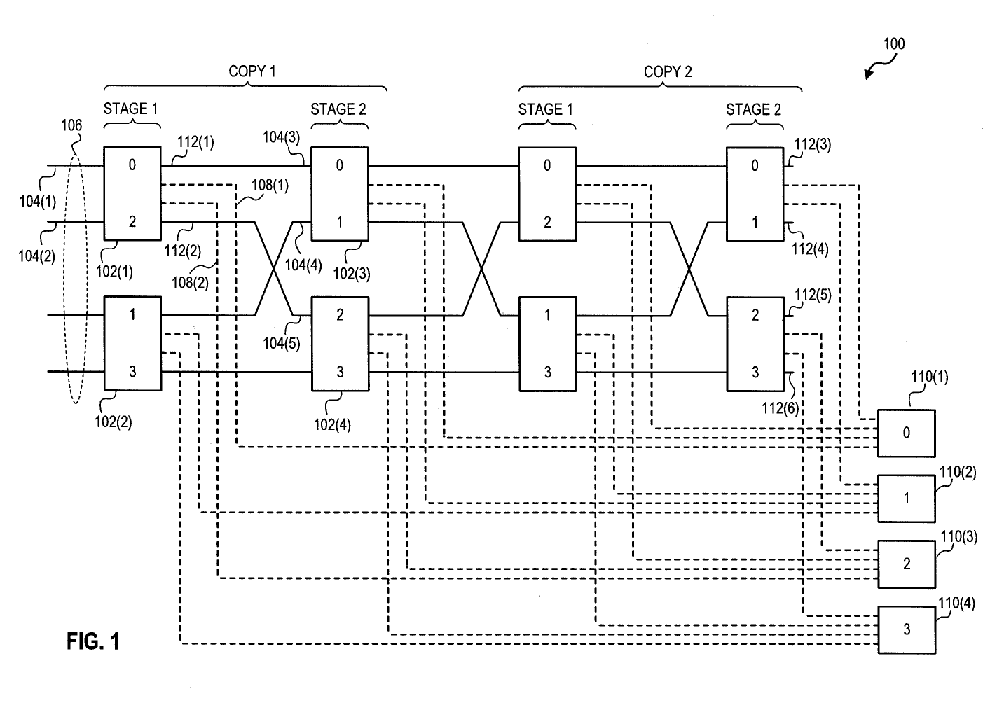

FIG. 1 shows one multistage switching fabric panel 100. Panel 100, which has an I-Cubeout (“ICO”) network architecture, is operable to route data units or cells from primary inputs 106 to their proper destination queues 110. Panel 100 has a network size N, where N is a positive integer representing the number of constituent inputs 104 of primary inputs 106 as well as the number of destination queues 110. Although panel 100 is illustrated in FIG. 1 with N being 4, panel 100 can have a different size.

Panel 100 includes at least n stages of switching elements 102, where n=log₂N. Each stage has N/2 switching elements 102. Panel 100 has at least one full copy of the n stages. Additional full or partial copies of the n stages can be added to improve performance. For example, panel 100 is illustrated in FIG. 1 as including two copies of stages. It should be noted that although the first copy of stages must be complete (i.e., include all n stages), subsequent copies can be incomplete.

Each switching element 102 has dimensions of b×2b, meaning that the switching element has b inputs 104 and 2b outputs (including b local outputs 108 and b remote outputs 112). Only some switching elements 102, inputs 104, and outputs 108, 112 are labeled in FIG. 1 for clarity. Adjacent stages are interconnected according to the indirect n-cube connecting pattern. Remote outlets 112 connect to the inputs 104 of subsequent stages, and local outlets 108 (shown by dashed lines) deliver routed cells from panel 100 to destination queues 110. For example, remote outputs 112(1), 112(2) of switching element 102(1) connect to inputs 104(3), 104(5) of switching elements 102(3), 102(4), respectively.

Let L be the index of line and be expressed in binary notation as follows (where n=log₂N):

L=2ⁿ⁻¹l₁+2ⁿ⁻²l₂+ . . . +2lₙ₋₁lₙ (1)

Accordingly, the indices of the lines incident on either side of a switching element 102 differ only in lₖ. Specifically, the two indices of any switching element 102 in the same stage differ by a constant; those in stage 1 differ by N/2, those in stage 2 differ by N/4 and so on.

An ICO network, such as panel 100, self-routes slightly differently than a normal delta class network. In particular, a routing tag is generated for each cell entering panel 100 at primary inputs 106 by using a bit-wise XOR of the cell's local primary input address and destination address. Subsequently, as the cell travels through panel 100, its path through a given switching element 102 is a function of its tag bit corresponding the switching element's stage. If a tag bit corresponding to a stage is 1, the cell needs to take the “cross” state of the switching element of the stage. After the non-zero tag bit is corrected, it is set to 0. If a tag bit corresponding to a stage is 0, the cell just passes straight through the switching element 102 of the stage. When all the tag bits become 0, the cell has reached its destined row and may take the local outlet 108 at the switching element to its appropriate destination queue 110, through which an output line card (“LC”) may be connected.

A cell's routing tag is cyclically rotated leftward by log₂b bits after the cell advances to the next stage. Only the leftmost tag bits are examined at each switching element 102. Such characteristic unifies switching element design and eliminates correlating each switching element's design with its stage number.

Each switching element 102 includes a local scheduler that follows the shortest path algorithm. A cell's distance to its appropriate destination queue is defined as the rightmost nonzero bit position q of its tag, where the cell needs to travel at least q stages before reaching its destination queue. If two conflicting cells arrive at a given switching element 102 (e.g., one cell is to pass crosswise through the switching element and the other cell is to pass straight through the switching element), the local scheduler gives priority to the cell with a smaller distance and deflects the cell with a larger distance. Such operation helps minimize the number of cells in the switching fabric and thereby helps improve system performance. If the two conflicting cells have an identical distance, one of the cells is, for example, randomly chosen to receive priority.

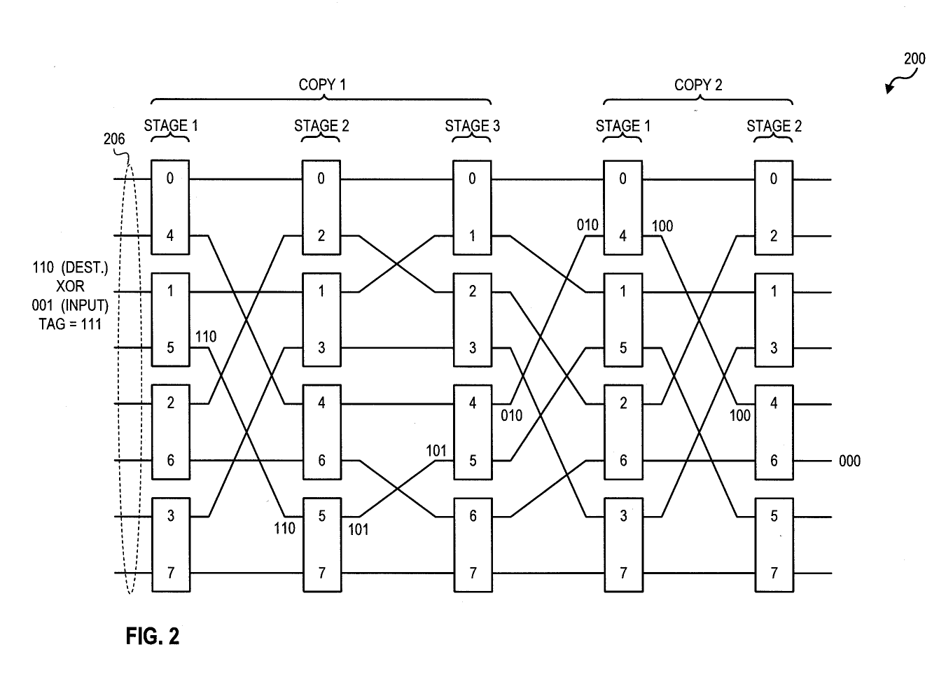

One routing example is shown in FIG. 2, which shows a multistage switching fabric panel 200 having a network size of 8. Panel 200, which is an embodiment of panel 100 of FIG. 1, includes a first full copy of stages and a second partial copy of stages. Destination queues are not shown in FIG. 2 for clarity.

In the example of FIG. 2, a cell with destination 110 enters switching fabric 200 at input 001 of primary inputs 206. A tag 111 is generated by XOR operation. The cell travels from one switching element to the next through panel 200 and arrives at destination 110 at stage 2 of copy 2 with tag 000. Other examples of multistage switching fabrics based on the ICO network may be found in the following paper, which is incorporated herein by reference: N. F. Tzeng, Multistage-Based Switching Fabrics for Scalable Routers”, IEEE Trans. On Parallel and Distributed Systems, Vol. 15, No. 4, pp. 304-318, April 2004 (“Tzeng”).

In multistage switching fabrics, such as panels 100 and 200 of FIGS. 1 and 2 respectively, a cell that enters the switching fabric's primary inputs may fail to route—that is, the cell may fail to reach its appropriate destination queue after traveling through all stages of the switching fabric and reaching the primary outputs. Such primary outputs are the local outputs of the switching fabric's last stage. For example, local outputs 112(3)-112(6) are the primary outputs of panel 100. A failure to route occurs, for example, due to congestion at a switching element or a failure within the switching fabric. Cells that fail to route are ordinarily discarded or dropped, resulting in performance degradation.

However, an ICO network's efficiency and performance can be increased by reintroducing cells that failed to route back into the network. Such reintroduction of cells may be referred to as recirculation and gives cells that failed to route at least one more opportunity to reach their destination queues before being dropped.

In an ICO network supporting recirculation, a cell that failed to route is reintroduced to the switching fabric at a reentry point. Various recirculation methods have been proposed, including the static connection recirculation method, the first available point (“FA”) recirculation method, and first 1 bit in routing tag (“FO”) recirculation method. Such recirculation methods specify how a cell is reintroduced into the switching fabric. In the static connection recirculation method, cells are always reintroduced at the same reentry points. In contrast, in the FA and FO recirculation methods, cells may be reintroduced at one of a number of reentry points (e.g., the first available reentry point in the case of the FA scheme). Examples of recirculation methods may be found in Tzeng.

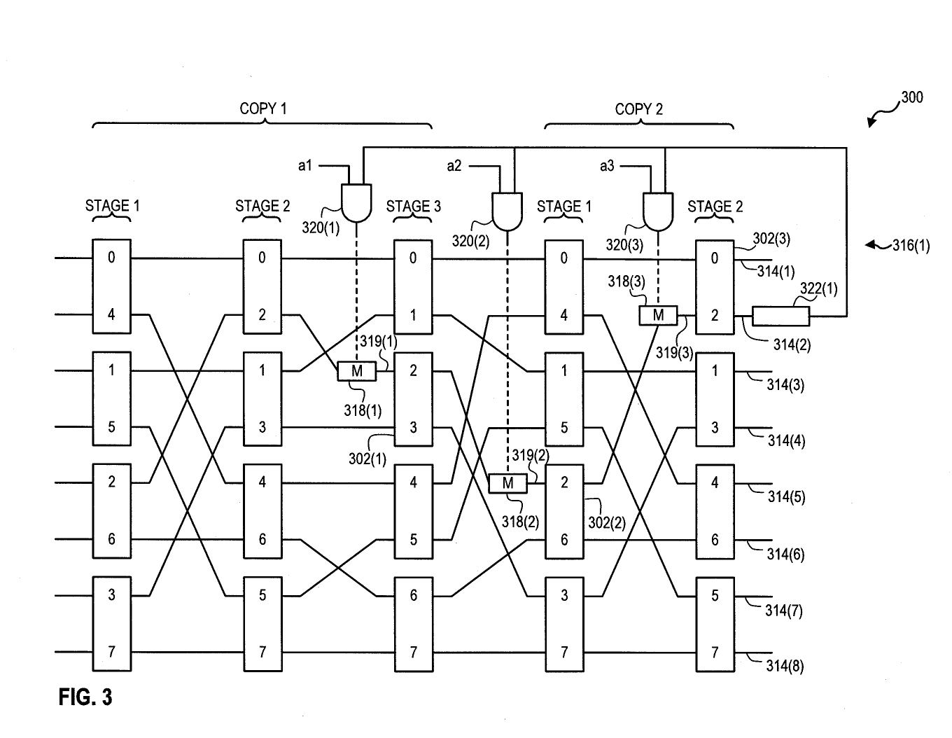

FIG. 3 shows one multistage switching fabric panel 300 with recirculation. Panel 300 is illustrated as having a network size of 8 and five stages; however, network size and/or number of stages may be varied. Only several switching elements 302 are labeled in FIG. 3 to promote clarity, and destination queues are not shown in FIG. 3 to promote clarity.

In panel 300, a respective recirculating subsystem 316 is communicatively coupled to each primary output 314 to recirculate cells that reached the primary output back into switching fabric 300. However, only a single recirculating subsystem 316(1) is shown in FIG. 3, to promote illustrative clarity. Although recirculating subsystem 316(1) is shown as being operable to recirculate cells back into switching fabric 300 at one of three possible reentry points 319, the number of reentry points 319 may be varied (e.g., only a single reentry point 319 is used if the static connection recirculation method is employed).

In some embodiments of panel 300, each recirculating subsystem 316 recirculates cells back into switching fabric 300 at reentry points 319 in the same logical row as the primary output 314 that the recirculating subsystem is connected to. For example, recirculation subsystem 316(1) recirculates a cell that reaches primary output 314(2) back into switching fabric 300 via reentry point 319(1) through multiplexer 318(1), via reentry point 319(2) through multiplexer 318(2), or via reentry point 319(3) through multiplexer 318(3).

Some embodiments of panel 300 support one of the FA or FO recirculation methods. In such embodiments, each recirculating subsystem 316 includes a tag shifter 322 as well as gates 320. Tag shifter 322 shifts a cell's tag depending on which reentry point 319 the cell is to utilize, and gates 320 control which reentry point 319 the cell is to utilize. Other embodiments of panel 300 support a static connection recirculation method having only a single reentry point 319 for each recirculating subsystem 316. Such embodiments do not include tag shifters 322 or gates 320. It may be preferable to dispose reentry points 319 primarily or completely in the last copy of stages, such as illustrated in FIG. 3, to avoid repetitive collisions at previous copies of stages.

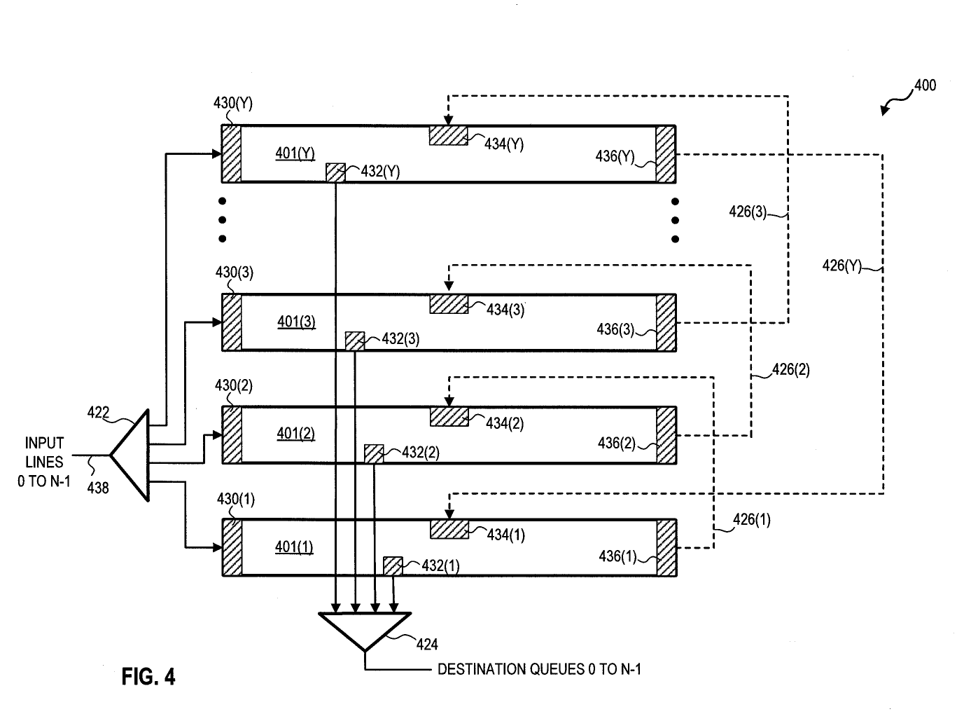

FIG. 4 shows one multistage switching fabric 400 including Y multistage switching fabric panels 401, where Y is an integer greater than one. In some embodiments, Y=2, which may represent an optimum balance between performance and cost, as discussed below. Although possible applications of switching fabric 400 include router or switch applications, switching fabric 400 may be used in other applications requiring cell routing or switching.

Each panel 401 includes primary inputs 430 for receiving cells to be routed to a destination queue, local outputs 432 for outputting routed cells to destination queues, primary outputs 436 for outputting cells that failed to route, and reentry points 434 for introducing non-routed cells into the panel. A respective recirculation connection 426 communicatively couples each panel's primary outputs 436 to another panel's reentry points 434. Recirculation connections 426, for example, collectively couple each of Y panels 401 in a loop, as shown in FIG. 4. Switching fabric 400 may be referred to as an “interleaved” switching fabric due to a plurality of panels 401 being coupled by recirculation connections 426.

In multistage switching fabric panel 300 of FIG. 3, if a cell fails to route, the cell is recirculated within the panel. In contrast, if a cell fails to route within a given panel 401 of switching fabric 400, the cell is recirculated to a different panel 401 via a recirculation connection 426. Recirculating cells among different panels 401 may advantageously allow switching fabric 400 to exhibit improved performance and/or reliability compared to multistage switching fabric panels that recirculate cells within one panel, as discussed below.

Panels 401 are, for example, based on an I-Cubeout (“ICO”) network that supports recirculation, where adjacent stages are interconnected according to an indirect n-cube connecting pattern, and a recirculation method such as the static connection recirculation method, the FA recirculation method, or the FO recirculation method is supported. For example, each panel 401 may be an embodiment of panel 300 of FIG. 3 and employ the FA recirculation method where recirculation connections 426 recirculate cells. However, panels 401 could be based on other suitable architectures.

Switching fabric 400 further includes at least demultiplexer subsystem 422, which is communicatively coupled to each panel 401's primary inputs 430, for interfacing switching fabric 400 with input lines 438. In particular, demultiplexer subsystem 422 receives cells from inputs 438 and distributes the cells among the Y panels 401. Demultiplexor subsystem 422, for example, distributes the cells among panels 401 sequentially—that is, a cell is distributed to one panel 401, a subsequent cell is distributed to a next panel 401, and so on. As another example, demultiplexer subsystem 422 may distribute cells to panels based on each panel's load (e.g., to a panel 401 having the smallest load), or based on cell destination address (e.g., to a panel 401 best able to route the cell to its proper destination queue). In some embodiments, demultiplexer subsystem 422 includes N individual demultiplexers, where N is switch fabric 400's network size.

Switching fabric 400 further includes at least one multiplexer subsystem 424, which is communicatively coupled to each panel 401's local outputs 432, for interfacing switching fabric 400 with destination queues, such as destination queues similar to those of FIG. 1. In some embodiments, multiplexer subsystem 424 includes N individual multiplexers.

Some embodiments of switching fabric 400 are synchronized with a common clock signal. For example, all cells may move to a next stage or a local outlet under the control of one clock signal. As another example, in some embodiments, all cells from demultiplexer subsystem 422 enter a panel ((t mod Y)+1) at a clock cycle t, for each of Y panels from 1 to Y.

In some embodiments of switching fabric 400, a concentrator is located before each destination queue for terminating the cells from local outputs 432. Each concentrator has a speedup ξ, where speedup is the ratio of the concentrator's speed to the speed of links interfacing with the concentrator. Accordingly, each concentrator is operable to receive up to ξ cells in one clock cycle, typically from the active rightmost to leftmost stages, regardless of what panel 401 a given stage is part of.

It may be advantageous to design switching fabric 400's constituent switching elements to process only fixed length cells in order to simply hardware design and increase switching element processing efficiency. In such case, variable length packets can be handled by segmenting them into the fix-sized cells before inputting them into switching fabric 400 and by subsequently reassembling cells after routing by switching fabric 400. One example of a mechanism to keep track of cells in transmission for resequencing at their destinations is disclosed in Tzeng.

If traffic is assumed to be evenly loaded between panels 401, each panel runs at load (p/Y), in which p is the load from outside. Accordingly, as the number of panels are increased from Y to Y+1, the difference in each panel's load is given by p/(Y²+Y). Thus, the difference in each panel's load decreases quickly as Y increases, and Y=2 may represent a good compromise between throughput and hardware cost. However, increasing Y typically increases fault tolerance of switching fabric 400. Thus, if high fault tolerance is desired, it may be desirable for Y to be at least 3.

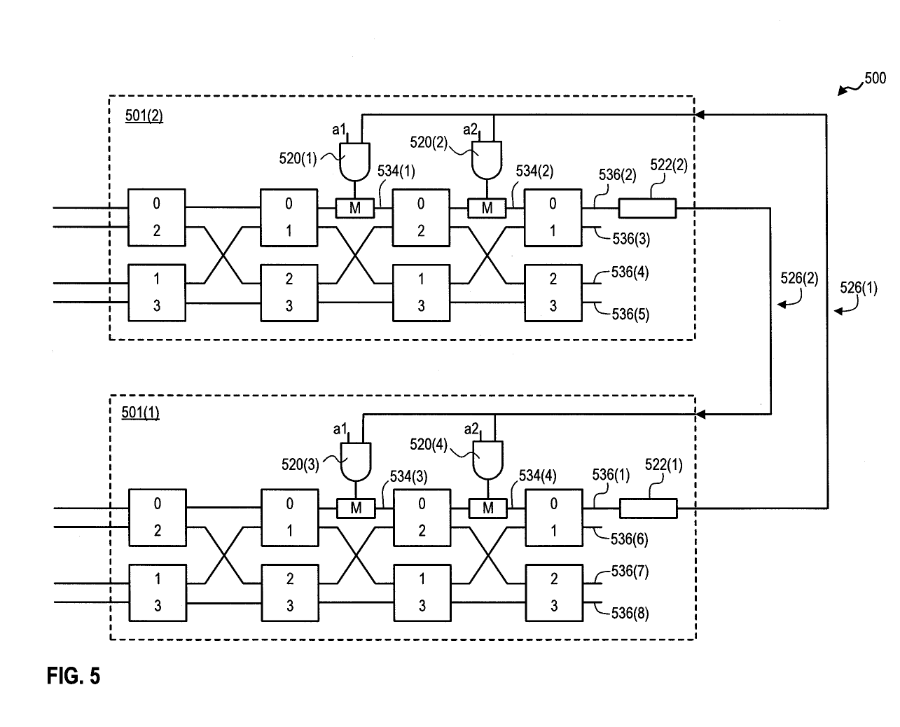

FIG. 5 schematically illustrates one interleaved multistage switching fabric 500, which is an embodiment of switching fabric 400 of FIG. 4. Switching fabric 500 includes panels 501(1) and 502(2), each of which are embodiments of single panel multistage switching fabric 300 of FIG. 3. Switching fabric 500 is shown having a network size of 4. However, switching fabric 500 could be modified to have a different network size. Additionally, although switching fabric 500 is illustrated in FIG. 5 as including two panels 501, switching fabric 500 could include additional panels 501, and each panel could include a different number of stages.

Switching fabric 500 includes a respective recirculation connection 526 for each panel 501. In particular, each recirculation connection 526 couples primary outputs 536 of one panel 501 to reentry points 534 of another panel 501. However, it should be noted that only parts of each recirculation connection 526(1), 526(2) are shown in FIG. 5 for clarity, and that only several reentry points 534 are labeled in FIG. 5 for clarity. For example, only the part of recirculation connection 526(1) that connects primary output 536(1) to entry points 534 of panel 501(2) is shown. In actuality, recirculation connection 526(1) includes additional elements that are not shown for connecting each of primary outputs 536(6)-536(8) to appropriate reentry points 534 in panel 501(2). Similarly, only the part of recirculation connection 526(2) that connects primary output 536(2) to reentry points 534 of panel 501(1) is shown. Recirculation connection 526(2) includes additional elements that are not shown for connecting each of primary outputs 536(3)-536(5) to appropriate reentry points 534 in panel 501(1). As shown in FIG. 5, recirculation connections 526 may include tag shifters 522 for shifting cells' routing tags as well as gates 520 for controlling which reentry point 534 a cell utilizes to enter a panel 501.

In this document, the notation SX/PY may be used. X specifies the number of stages per panel, and Y specifies the number of panels. For example, switching fabric 500, which is shown having two panels 501 and four stages per panel, could be described as being a S4/P2 switching fabric.

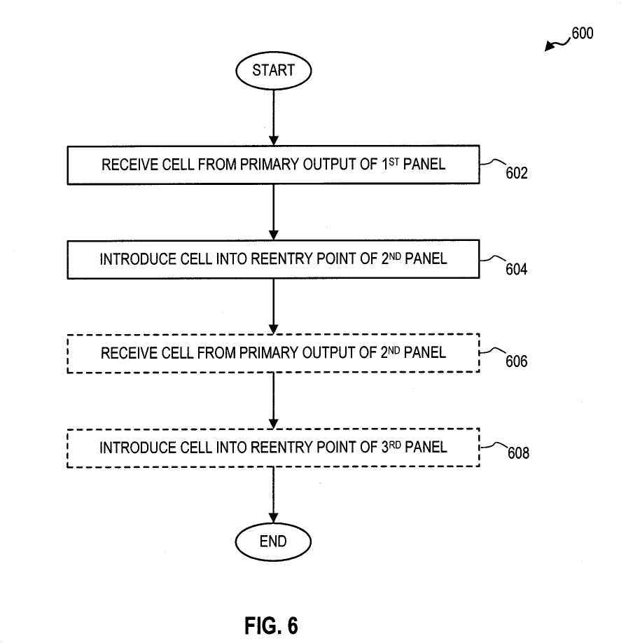

FIG. 6 shows one method 600 for recirculating cells that fail to route in a switching fabric. Method 600 begins with step 602 of receiving a first cell that failed to route from a primary output of a first multistage switching fabric panel. An example of step 602 is receiving a first cell that failed to route from primary outputs 436(1) of panel 401(1) of FIG. 4. In step 604, the first cell received in step 602 is introduced into a reentry point of a second multistage switching fabric panel. An example of step 604 is introducing the first cell to panel 401(2) via recirculation connection 426(1) and reentry points 434(2).

Method 600 optionally includes additional steps 606 and 608 that are executed if the first cell failed to route in the second panel. In step 606, the first cell is received from a primary output of the second panel, and in step 608, the first cell is introduced into a reentry point of a third panel. An example of step 606 is receiving the first cell from primary outputs 436(2) of panel 401(2), and an example of step 608 is introducing the first cell into panel 401(3) via recirculation connection 426(2) and reentry points 434(3).

Switching fabric 400 may offer advantages over other switching fabrics. First, switching fabric 400 has a relatively low complexity, thereby promoting scalability. For example, the number of switching elements increases linearly with network size in switching fabric 400. In contrast, the number of elements in the single stage crossbar architecture increases exponentially with network size.

Additionally, although switching fabric 400 typically has a relatively low complexity, it nevertheless may exhibit better performance than some prior art switching fabrics. For example, an S6/P2 embodiment of switching fabric 400 is expected to exhibit around a third of the latency of a S12/P1 switching fabric with only a negligible drop rate increase. As another example, an S8/P2 embodiment of switching fabric 400 is expected to outperform a S12/P1 single panel switching fabric at any traffic pattern. It should be noted that the S8/P2 switching fabric requires only a small increase in hardware resources over the S12/P1 switching fabric.

One reason that switching fabric 400 may exhibit better performance than some prior art switching fabrics is that switching fabric 400's multiple panels 401 and recirculation connections 426 help balance cell traffic and ease hot flows after collisions. Additionally, some embodiments of switching fabric 400 also advantageously avoid the non-linear performance degradation that commonly occurs in single multistage switching fabric panels during heavy load conditions (0.5≦p≦1) by distributing the load among panels 401. For example, as previously noted, if traffic is assumed to be evenly loaded between panels 401, each panel runs at load (p/Y), in which p is the load from outside. The total cell drop rate (or throughput) is the sum of that from each panel. For example, when Y=2 and p=1.0, each panel runs at load=0.5, and the total cell drop rate is equal to 2× (cell drop rate at load 0.5 for a single panel). When Y=3 and p=0.9, each panel runs at load=0.3, and the total cell drop rate equals to 3× (cell drop rate at load 0.3 for a single panel). Accordingly, in some embodiments of switching fabric 400, each panel typically operates with a load of less than or equal to 0.5, thereby avoiding non-linear performance degradation associated with heavy loads.

Simulations have shown that some embodiments of switching fabric 400 outperform single multistage switching fabric panels having the same length, or number of stages, under different traffic settings. For example, simulations have shown embodiments of switching fabric 400 achieve speedups (over a single multistage switching fabric panel) of 3.4 and 2.25 under uniform and hot-spot traffic patterns, respectively, at maximum load (p=1). As another example, simulations under different traffic patterns have shown that some embodiments of switching fabric 400 are far less prone to suffer a mean latency increase due to load congestion than single panel switching fabrics. In contrast, the mean latency deteriorates considerably as the load increases in single multistage switching fabric panels. Additional simulation results are discussed below.

Furthermore, switching fabric 400 may show significant tolerance against internal hardware failures. In some embodiments of switching fabric 400, a faulty switching element is treated in a similar fashion to a hot congestion area—that is, traffic is deflected away from the faulty switching element. The parallel architecture of switching fabric 400 may also advantageously provide inherent redundancy and associated fault tolerance. For example, under a worst case scenario where one panel 401 in a two panel embodiment of switching fabric 400 is non-functional, the remaining functional panel 401 will permit the switching fabric to continue operate with some performance degradation. In contrast, in the case of a failure of the panel of a S12/P1 system, the entire system may malfunction. Simulations under different fault models have revealed that some embodiments of switching fabric 400 are highly fault tolerant against internal hardware failures compared to single multistage switching fabric panels.

Moreover, some embodiments of switching fabric 400 can be utilized as a Redundant Array of Independent Fabrics (“RAIF”) analogous to a Redundant Array of Independent (or Inexpensive) Disks (“RAID”). Such RAIF systems, for example, are scalable and exhibit high performance and reliability. In particular, some RAIF systems will continue to operate even after one panel 401 fails. For example, a S6/P1 system can be upgraded to form an embodiment of switching fabric 400 by adding additional multistage switching fabric panels. The system could function as a RAIF 0 system (similar to RAID level 0), where panels 401 operate in parallel. As another example, an embodiment of switching fabric 400 could function as a RAIF 1 system (similar to RAID level 1), where one panel of the RAIF 1 system operates in a standby mode when there is no fault and replaces a malfunctioning panel when there is a fault. By having a panel operate in a standby mode when there is no fault, power consumption during normal operation may be reduced. As yet another example, RAIF 0 and 1 approaches could be combined to form a RAIF 2 system with Y panels (Y>2), where Y−1 panels operate in parallel, and one panel operates in a standby mode for fault tolerance.

### Simulations

Some embodiments of switching fabric 400 as well as single multistage switching fabric panels were simulated. System metrics that were observed during the simulations include cell drop rate and mean latency. Cell drop rate is equal to one minus throughput, and mean latency is the average time a cell takes to cross a switching fabric. The simulations were generally conducted under the following conditions:
N=256;
Each switching element had dimensions of 4×8;
Y=2 in the case of embodiments of switching fabric 400;
Each switching element output had local and remote output queues equipped with 12-cell buffers and could receive up to t cells during each cycle, where ξ=2;
Destination queues were run with a speedup of two; and
The FA recirculation scheme was used.

### I. Uniform Traffic Patterns:

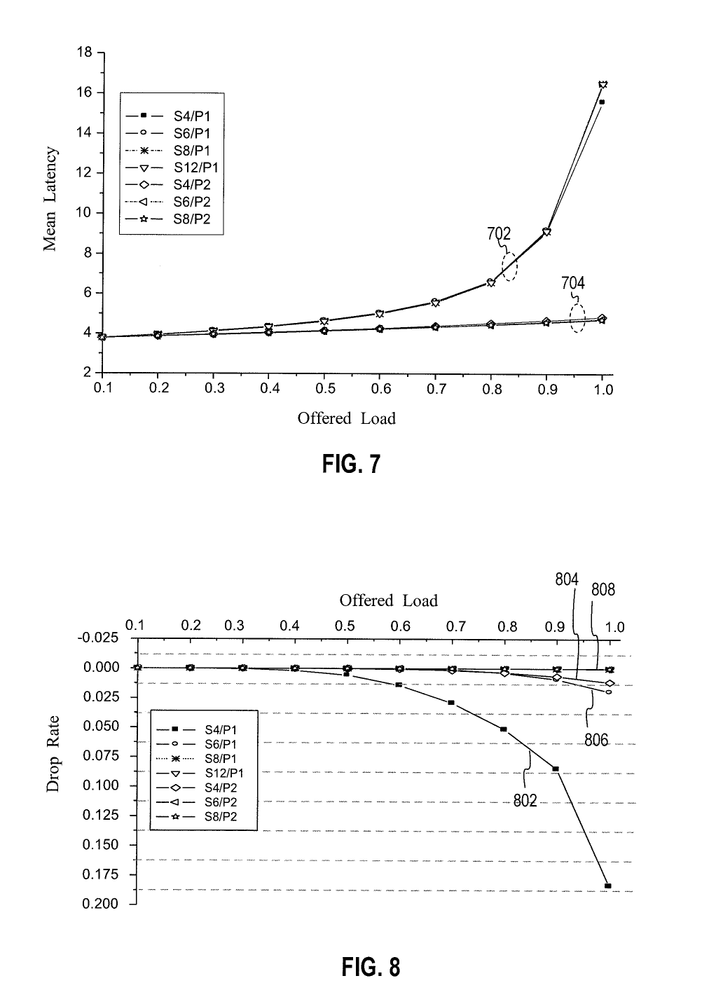

The simulations of FIGS. 7 and 8 were conducted assuming a uniform traffic pattern, where cells at the panels' primary inputs chose each destination output with equal probability. FIG. 7 shows a graph of mean latency versus offered load for single multistage switching fabric panels (Y=1) and for embodiments of switching fabric 400 with two panels (Y=2). For Y=1 (curves 702), systems were simulated with 4, 6, 8 and 12 stages per panel. For Y=2 (curves 704), systems were simulated with 4, 6, and 8 stages per panel. It should be noted that a S8/P1 system has the same number of stages as the S4/P2 system. Similarly, a S12/P1 system has the same number of stages as a S6/P2 system. Each of the S4/P1 and S4/P2 systems have panels of the same length (i.e., each panel has the same number of stages). Similarly, the S6/P1 and the S6/P2 systems have panels of the same length, and the S8/P1 and S8/P2 systems have panels of the same length.

From FIG. 7, it can be observed that at full load (p=1.0), the interleaved switching fabrics exhibited a mean latency of around 4.7 cycles while the single multistage switching fabric panels exhibited a mean latency of around 16 cycles. Such difference in latency represents a speedup of 3.4. At load p=0.5, the S4/P1 system has a mean latency of 4.65 cycles, which is close to the S4/P2 system's latency of 4.7 cycles at p=1.0. Accordingly, the embodiments of switching fabric 400 simulated in FIG. 7 advantageously do not exhibit the non-linear latency increase characteristic of the simulated single multistage switching fabric panels when 0.5≦p≦1.0.

FIG. 8 shows a graph of drop rate versus offered load. As can be observed from the graph, the S4/P1 system (curve 802) had a much larger drop rate than the S4/P2 system (curve 804), even though both systems have panels of the same length. Additionally, the S6/P1 system (curve 806) had a much larger drop rate than the S6/P2 system, even though both systems had panels of the same length.

The S6/P2 system had a slight increase in drop rate of 0.013% while the S12/P1 system (curve 808) had essentially no increase in drop rate. However, as shown in FIG. 7, the S12/P1 system had a much larger latency increase at heavy load than the S6/P2 system. Accordingly, the S6/P2 system may be preferred for real time connectionless applications. Additionally, in connection-oriented applications, TCP's ARQ (Automatic Repeat Request) scheme may compensate for the S6/P2 system's drop rate increase.

### II. Hot Spot Traffic Patterns:

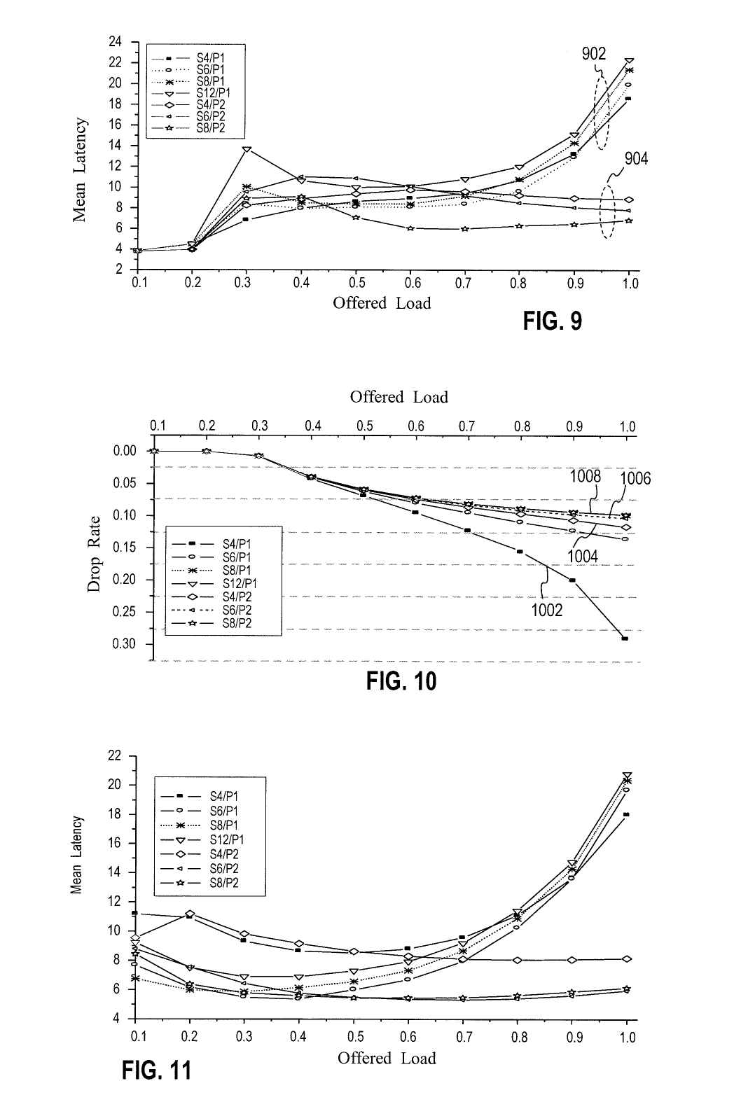

Traffic through switching fabrics is usually nonuniform. In particular, there are generally some hot spots on the network, such as due to connections with file servers, connections to popular web sites, and/or an uplink to a backbone network. In the simulations of FIGS. 9 and 10, a general five hot-spot model was used to measure switching fabric performance under nonuniform traffic patterns.

In the simulations of FIGS. 9 and 10, five hot spots (consisting of about 2% of the total outputs) were chosen at output ports 19, 63, 135, 182, and 237. The five hot spots collectively received η=12 percent hot traffic in addition to their fair share of the regular traffic (i.e., the remaining 88 percent of the traffic). The regular traffic was evenly distributed over all 256 output ports. The hot traffic nearly saturated each switching fabric due to the separation of the hot spot ports.

As shown in FIG. 9, which is a graph of mean latency versus offered load, the interleaved switching fabrics (curves 904) generally exhibited a much lower mean latency increase as load increased compared to the single multistage switching fabric panels (curves 902). For example, at p=1.0, the systems with Y=2 exhibited a latency of around 8 cycles, while the systems with Y=1 exhibited a latency of around 18 or more cycles. Accordingly, switching from Y=1 to Y=2 resulted in a switching speedup of around 2.25. In the single multistage switching fabric panels (Y=1), latency increased as the number of stages in each panel were increased due to the rightmost stages having higher priority access to the destination queues than the leftmost stages.

It should be noted that in the double panel systems (Y=2) of FIG. 9, the S4/P2 system had a larger mean latency at p=1.0 than the S6/P2 and S8/P2 systems. Such relatively large latency of the S4/P2 system is due to the system having a single copy of stages, which resulted in intense congestion and corresponding deflections. These deflections required the deflected tag bits to be corrected in following stages, which increased the overall mean latency.

FIG. 10 is a graph of drop rate versus offered load. The S4/P1 system (curve 1002) had the highest drop rate due to the recirculated cells colliding with cells just received from the primary inputs. The S4/P2 system (curve 1004) balanced the recirculated cells between each of the two panels and decoupled the cells with the input flows. Accordingly, the S4/P2 system exhibited a drop rate of 11.7% at load p=1.0, while the S4/P1 system exhibited a drop rate of 29.1% at load p=1.0. The S6/P2 system (curve 1006) also showed a lower drop rate than the S6/P1 system at heavy load.

Although the S6/P2 system and S12/P1 system (curve 1008) each have the same number of switching elements, the S6/P2 system had a drop rate 10.3% while the S12/P1 system has a slightly lower drop rate of 9.8% at p=1.0. However, the S12/P1 system had a latency of about 22.4 while the S6/P2 system had a latency of about 7.8 at load p=1.0, as shown in FIG. 9. Accordingly, the S6/P2 system outperformed the S12/P1 system under non-uniform traffic conditions as well as under uniform traffic conditions.

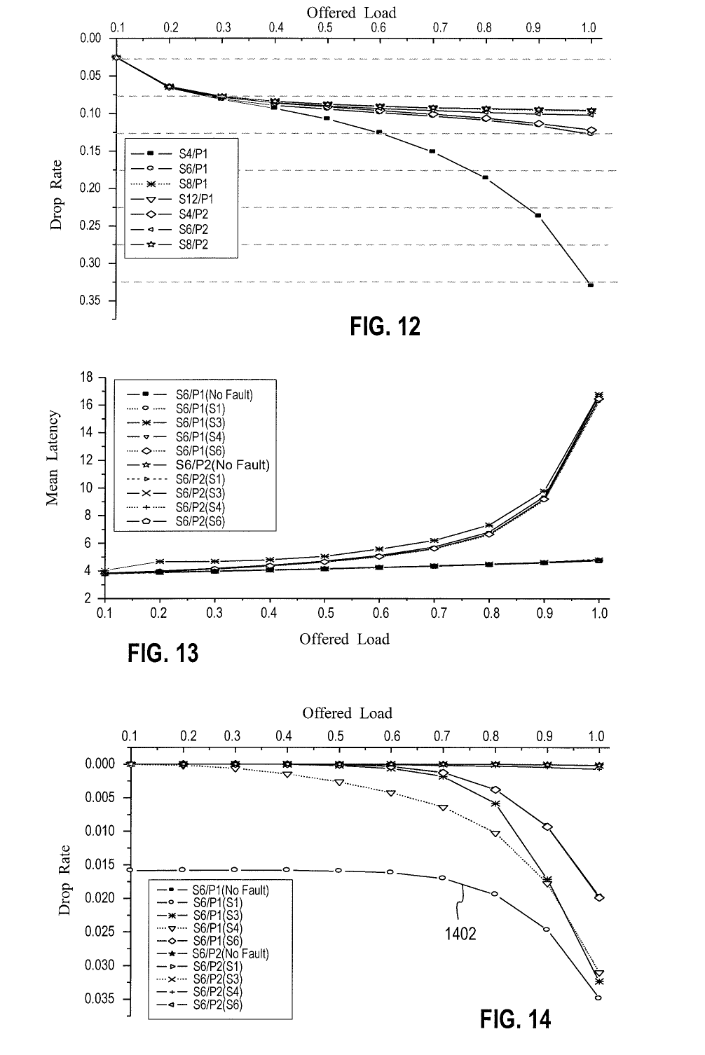

FIGS. 11 and 12 show graphs of mean latency versus offered load and drop rate versus offered load, respectively. In the simulations of FIGS. 11 and 12, a single hotspot was assumed. This hotspot, which was located at output port 0, collectively received η=10 percent hot traffic in addition to its fair share of the regular traffic (i.e., 90% of the remaining traffic). The regular traffic was evenly distributed over all 256 output ports. FIGS. 11 and 12 show results similar to those of FIGS. 9 and 10.

### III. Fault Tolerance:

Possible points of failure in multistage switching fabrics include link failures and switching element failures. Switching element hardware is typically more complex than link connections and therefore more prone to fail than link connections. An internal link fault could also be modeled as a switching element fault because a faulty link renders the following switching element inaccessible. Accordingly, a switching element fault model was used to evaluate fault tolerance in the following simulations.

### A. Single Fault Model:

In the simulated single fault model, a single switching element is faulty and will not accept any cells. Thus, cells that need to pass through the faulty switching element are deflected in prior stages. If the faulty switching element is located in a last copy of stages, the recirculated cells need to jump this faulty point if the FA recirculation method is used. In the following simulations, the faulty switching element is assumed to be located in row 31 of various stages.

A fault's effect will depend on the faulty switching element's location due to hot-spot traffic saturating parts of switching fabrics along the traffic's path. Accordingly, the following fault tolerance simulations assume uniform traffic.

1. Single Multistage Switching Fabric Panel v. Interleaved Switching Fabrics with Y=2:

FIGS. 13 and 14 show how a single fault impacts performance of both interleaved switching fabrics and single multistage switching fabric panels where each panel has a length of six stages. In particular, FIG. 13 is a graph of mean latency versus offered load, and FIG. 14 is a graph of drop rate versus offered load. The fault stage locations are labeled in parentheses in FIGS. 13 and 14.

Fault location was shown to affect degradation of the S6/P1 system, particularly with respect to drop rate. As shown in FIG. 14, when the faulty switching element of the S6/P1 system was in the first stage (curve 1402), the drop rate started at 1.59%. There were a total of 64 switching elements in each stage of the simulated S6/P1 system, and 1/64=1.56%. Accordingly, one faulty switching element in stage one means that 1.56% of the input traffic will be lost immediately without switching through the fabrics. Thus, the simulation results essentially match the theoretical value and support the proposition that the first stage is the most critical stage for single multistage switching fabric panels. Another important stage of the S6/P1 system is the first stage of last copy, which also merges with the first entrance point when using the FA recirculation method. If the fault happens to be at this stage, both the latency and drop rate deteriorate noticeably, with a 3.23% drop rate as opposed to 1.97% for the fault-free situation. The S6/P1 system's performance was less sensitive to a fault in the last stage than in other stages due to most of the cells having been switched to destination queues in stages prior to the last stage.

A fault in the S6/P2 system had a negligible impact on performance regardless of the stage in which the fault occurred. Accordingly, some embodiments of switching fabric 400 not only perform better than single multistage switching fabric panels, but also tolerate a single hardware failure. For example, although a fault in a first stage of the S6/P1 system is effectively fatal, cells have a chance to divert around a failed first stage in the S6/P2 system.

### 2. Identical Number of Stages:

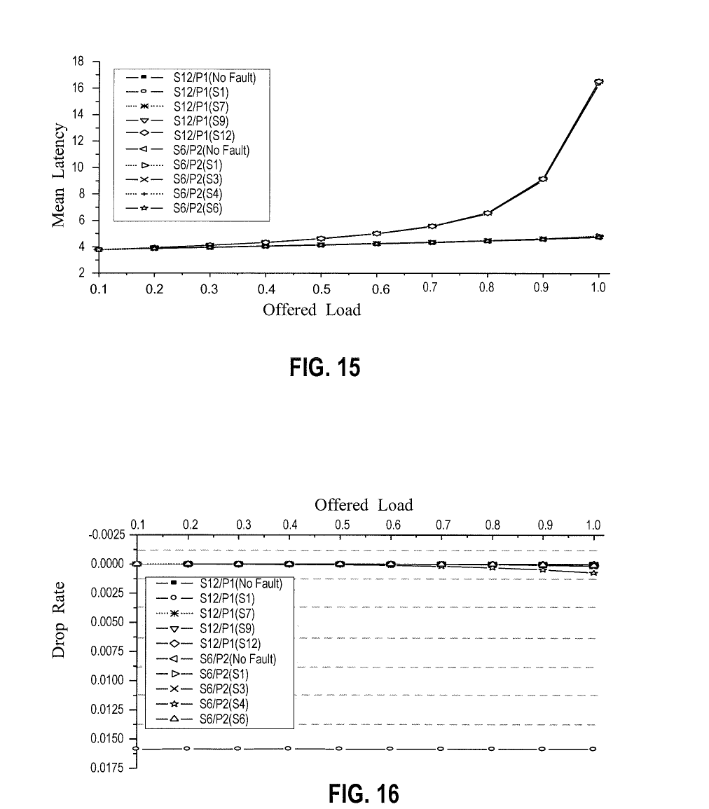

FIGS. 15 and 16 show how a single fault impacts performance of both interleaved switching fabrics and single multistage switching fabric panels, where both have the same total number of stages and therefore require about the same amount of hardware resources. In particular, S12/P1 systems are compared with S6/P2 systems, where both systems have twelve stages. Mean latency and drop rate versus offered load are depicted in FIGS. 15 and 16, respectively. The simulations indicate that the S12/P1 system suffered severely from a fault in its first stage, as did the S6/P1 system simulated in FIG. 14. With the exception of a fault in the first stage, the S12/P1 system will tolerate a single fault error in a manner similar to the S6/P2 system. However, as FIGS. 7 and 15 show, the S12/P1 system exhibited over 3 times the mean latency of the S6/P2 systems at heavy offered load. Accordingly, the S6/P2 system may be considered to outperform the S12/P1 system.

### B. Multiple Fault Model

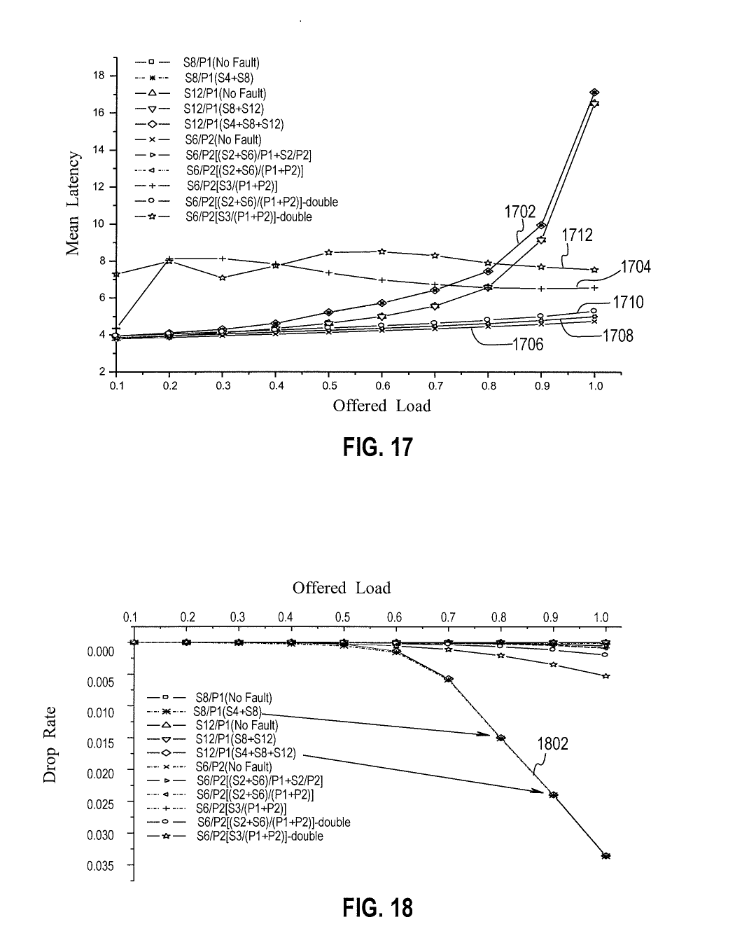

The multiple fault model is considerably more complicated than the single fault model because of the numerous combinations of number of faults and fault locations. However, a fault in the same stage of plurality of copies of stages will generate a switching bottleneck and cause performance to deteriorate significantly. The simulations of FIGS. 17 and 18 depict this situation. FIG. 17 is a graph of mean latency versus offered load, and FIG. 18 is a graph of drop rate versus offered load. The fault locations are specified in the parentheses in FIGS. 17 and 18. For example, S8/P1(S4+S8) indicates that a fault occurred at stages 4 and 8 of the single panel. As another example, S6/P2[(S2+S6)/P1+S2/P2] indicates that faults occurred at stages 2 and 6 of panel 1, and that a fault occurred at stage 2 of panel 2. As yet another example, S6/P2[(S2+S6)/(P1+P2)] indicates that a fault occurred both at stages 2 and 6 for both panels. Because faults have a strong tendency to happen in contiguous (or nearby) areas, the simulations discussed below assume that each stage including a fault includes 4 consecutive faulty switching elements. The faulty switching elements are located in rows 30, 31, 32, and 33.

As it can be observed in FIGS. 17 and 18, the S8/P1(S4+S8) and S12/P1(S4+S8+S12) systems (curves 1702, 1802) were considerably impacted by this fault model, even though the S12/P1 system exhibited satisfactory performance against a single fault as shown in FIGS. 15 and 16. For example, the S8/P1(S4+S8) and S12/P1(S4+S8+S12) systems exhibit much greater latency than the corresponding fault-free systems. As another example, the S8/P1(S4+S8) and S12/P1(S4+S8+S12) systems exhibit a drop rate of 3.4% at load p=1.0, while the fault-free systems exhibited a drop rate of only 9.8×10⁻⁸ under the same condition.

In the S6/P2 systems, stages 2 and 6 (total of 4 affected stages) correct the second position of the tag bits. Accordingly, it is reasonable to expect that one or more redundant stages in S6/P2[(S2+S6)/P1] and S6/P2[(S2+S6)/P1+S2/P2] systems will compensate for the faults with slight degradations in latency and drop rate. Stage 3 of the S6/P2 systems (total of 2 affected stages) corrects the third position of the tag bits. If both instances of stage 3 fail, inferior performance is expected. However, it should be noted that the S6/P2[S3/(P1+P2)] and S6/P2[(S2+S6)/(P1+P2)] systems exhibited a negligible increase in drop rate, that is 0.086% as opposed to 0.013% of the corresponding fault-free systems.

The traffic in each panel of the S6/P2 systems is roughly half that of the single multistage switch fabric panels. Additionally, the S6/P2 systems may have double the FA recirculation points of the single multistage switching fabric panels. Such characteristics of S6/P2 systems broaden the switching path and mitigate collisions. Though correcting deflected cells in S6/P2[S3/(P1+P2)] systems (curve 1704) increases latency to 6.6 cycles from 4.7 cycles of a corresponding fault-free system (curve 1706) as shown in FIG. 17; 6.6 cycles is still far below the latency of counterpart S12/P1 systems. Moreover, with a total four stages to correct the second position of tag bits, the simulated S6/P2[(S2+S6)/(P1+P2)] system (curve 1708) achieved surprisingly good performance with low latency and drop rate.

Furthermore, simulations of extreme cases were performed where the number of faults were doubled to 8 faults in specific stages (row 28 to 35). FIGS. 17 and 18 show examples of this situation as S6/P2[(S2+S6)/(P1+P2)]-double (curve 1710) and S6/P2[S3/(P1+P2)]-double (curve 1712). At full load (p=1.0), the S6/P2[(S2+S6)/(P1+P2)]-double and S6/P2[S3/(P1+P2)]-double configurations had 5.3 cycles latency and 0.2% drop rate and 7.5 cycles latency and 0.5% drop rate, respectively. Again, the simulated interleaved systems showed much stronger fault tolerance capability than their single panel counterparts.

Changes may be made in the above methods and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. An interleaved multistage switching fabric, comprising:
Y multistage switching fabric panels, each panel having primary inputs for receiving cells to be routed, local outputs for outputting routed cells, primary outputs for outputting non-routed cells, and reentry points for introducing non-routed cells into the panel, Y being an integer greater than one;
at least one demultiplexer subsystem communicatively coupled to primary inputs of each panel, for interfacing the switching fabric with input lines;
at least one multiplexer subsystem communicatively coupled to local outputs of each panel, for interfacing the switching fabric with destination queues; and
Y recirculation connections, each recirculation connection communicatively coupling primary outputs of one panel to reentry points of another panel.

2. The switching fabric of claim 1, Y being equal to two.

3. The switching fabric of claim 1, each panel including a plurality of interconnected stages, each stage including a plurality of switching elements.

4. The switching fabric of claim 3, each panel having an I-Cubeout architecture, and adjacent stages being interconnected according to an indirect n-cube connecting pattern.

5. The switching fabric of claim 4, the recirculation connections being operable to execute a static connection recirculation method.

6. The switching fabric of claim 4, the recirculation connections being operable to execute a first available point recirculation method.

7. The switching fabric of claim 4, the recirculation connections being operable to execute a first one bit in routing tag recirculation method.

8. The switching fabric of claim 1, the at least one demultiplexer subsystem including Y demultiplexers.

9. The switching fabric of claim 1, the at least one demultiplexer subsystem being configured and arranged to route cells from the input lines to each of the Y panels in sequence.

10. The switching fabric of claim 1, the at least one demultiplexer subsystem being configured and arranged to route cells from the input lines to each of the Y panels according to each panel's load.

11. The switching fabric of claim 1, the at least one demultiplexer subsystem being configured and arranged to route cells from the input lines to each of the Y panels according to destination addresses of the cells.

12. The switching fabric of claim 1, the at least one multiplexer subsystem including Y multiplexers.

13. The switching fabric of claim 1, the recirculation connections being configured and arranged to transfer cells according to a common clock signal.

14. The switching fabric of claim 1, one of the Y panels being configured to operate in a standby mode during normal operation of the switching fabric and to replace a faulty panel during a fault mode.

15. The switching fabric of claim 1, each recirculation connection including a plurality of tag shifters for shifting cells' routing tags.

16. An interleaved multistage switching fabric, comprising:
Y multistage switching fabric panels, each panel having an I-Cubeout architecture, each panel having a plurality of stages of switching elements with adjacent stages interconnected according to an indirect n-cube connecting pattern, each panel having primary outputs for outputting non-routed cells, each panel having reentry points for introducing non-routed cells into the panel, Y being an integer greater than one; and
Y recirculation connections, each recirculation connection communicatively coupling primary outputs of one panel to reentry points of another panel.

17. The switching fabric of claim 16, the recirculation connections being operable to execute a first available point recirculation method.

18. The switching fabric of claim 16, one of the Y panels being configured to operate in a standby mode during normal operation of the switching fabric and to replace a faulty panel during a fault mode.

19. A method for recirculating cells that fail to route in a switching fabric, comprising:
receiving a first cell that failed to route from a primary output of a first multistage switching fabric panel; and
introducing the first cell into a reentry point of a second multistage switching fabric panel.

20. The method of claim 19, when the first cell fails to route in the second multistage switching fabric panel, receiving the first cell from a primary output of the second multistage switching fabric panel, and introducing the first cell into a reentry point of a third multistage switching fabric panel.
